(19) United States
(12) Patent Application Publication
(10) Pub. No.: US 2009/0222424 A1
(43) Pub. Date: Sep. 3, 2009

(54) METHOD AND APPARATUS FOR INTEGRATED LIFE THROUGH VIRTUAL CITIES

(76) Inventor: Benedict VAN, Palo Alto, CA (US)

Correspondence Address: PILLSBURY WINTHROP SHAW PITTMAN LLP, P.O. BOX 10500, MCLEAN, VA, 22102, US

(21) Appl. No.: 12/393,314

(22) Filed: Feb. 26, 2009

Related U.S. Application Data
(60) Provisional application No. 61/031,664, filed on Feb. 26, 2008.
(60) Provisional application No. 61/036,419, filed on Mar. 13, 2008.

(51) Int. Cl. G06F 3/048; G06F 17/30; G06Q 30/00; G06Q 50/00

(52) U.S. Cl. 707/3; 715/849; 705/27; 705/14; 715/757; 707/E17.108; 715/848

(57) ABSTRACT

A virtual cities server hosts one or more virtual cities, which in turn include one or more virtual environments with which a user interacts, where the one or more virtual environmental are three-dimensional spaces. The one or more virtual cities correspond to one or more physical cities, and virtual environments in turn correspond to physical environments in physical cities, thereby allowing businesses, organizations, and individual to establish virtual presences that correspond to physical presences and conduct transactions and activities that ultimately facilitate physical transactions and activities.

### CROSS-REFERENCE TO RELATED APPLICATIONS

This application claims priority from U.S. Provisional Patent Application No. 61/031,664, filed Feb. 26, 2008, and U.S. Provisional Patent Application No. 61/036,419, filed Mar. 13, 2008, the contents of which are incorporated herein by reference in its entirety.

### FIELD OF THE INVENTION

The present invention relates to Internet applications, and more particularly to a method and apparatus for providing integrated life activities through virtual cities via the Internet.

### BACKGROUND OF THE INVENTION

There has been a recent surge in “virtual world” technologies that allow users to assume virtual identities (e.g. avatars) and to interact with other users online, such as Second Life, Habbo, Zwinky, Gaia, Club Penguin, Webkinz. These are typically accessed via dedicated websites and subscriptions, and are typically closed systems (i.e. a user in one virtual community cannot directly interact with users in other virtual communities). These online communities sometimes further offer virtual items that can be bought and sold within their virtual worlds, such as virtual furniture, virtual clothing, virtual real estate, etc. One problem with existing “virtual world” products is that they are typically closed systems that are intended primarily to allow users to interact virtually without regard to real life activities, and typically do not allow other companies or individuals to promote their goods and services to other companies or individuals within the virtual worlds.

Meanwhile, on-line advertising is typically provided via banner ads, popups and search results displayed via search engines such as Google, Yahoo!, MSN and other highly-visited websites such as ESPN, CNN, etc. however, these ads are typically not visually entertaining, and do not scale very well to accessing or promoting local community goods and services. Moreover, they only provide advertisers with limited opportunities to reach consumers.

Therefore, it would be advantageous to provide improved methods and apparatuses for increasing the level of integrity between virtual worlds and the physical world, thereby allowing users to interact virtually with regard to real life activities.

### SUMMARY OF THE INVENTION

The present invention provides integrated life activities in a virtual world, including one or more virtual cities, within which individuals can navigate, use and receive information about goods and services, and through which both individuals and companies can promote their goods and services, and buy and sell real estate and other properties. Visitors to the virtual cities can view and use goods and services, and can build their own houses and furnish them, and allow other users to visit and rank them. Visitors can also establish their own businesses and open them to the public, thus offering users integrated life activities.

According to an embodiment of the invention, a virtual cities server hosts one or more virtual environments in which a user is able to interact with a virtual representation of a physical object, where the interaction can result in a transaction involving the physical object. The one or more virtual environmental are three-dimensional spaces, providing the user with a three-dimensional virtual shopping experience.

According to an embodiment of the invention, a virtual cities server hosts one or more virtual environments in which a user is able to interact with a virtual representation of a physical object, where the interaction can result in a physical action involving the physical object. The one or more virtual environmental are three-dimensional spaces, providing the user with a visual way of managing physical life activities.

According to an embodiment of the invention, a virtual cities server hosts one or more virtual cities, which in turn include one or more virtual environments with which a user interacts, where the one or more virtual environmental are three-dimensional spaces. The one or more virtual cities correspond to one or more physical cities, and virtual environments in turn correspond to physical environments in physical cities, thereby allowing businesses, organizations, and individual to establish virtual presences that correspond to physical presences and conduct transactions and activities that ultimately facilitate physical transactions and activities.

According to other aspects, advertisers are given unique opportunities to promote their goods and services. Billboards, buildings and other structures in the virtual world can be bought, sold and leased in the virtual cities, providing more interesting and appealing ads. Moreover, goods and services can be promoted within the virtual world, allowing users to view and use them, and thus providing advertisers with limitless opportunities to reach consumers with information about their goods and services.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram depicting a system 100 according to an embodiment of the present invention;

FIG. 2 illustrates an example virtual environment in a virtual city according to an embodiment of the present invention;

FIG. 3 illustrates another example virtual environment in a virtual city according to an embodiment of the present invention;

FIG. 4 illustrates an aerial view of a virtual city according to an embodiment of the present invention;

FIG. 5 illustrates an example virtual environment and a list of furniture that may be used to populate the virtual environment, according to an embodiment of the present invention;

FIG. 6 illustrates an example virtual environment representing a hotel lobby, according to an embodiment of the present invention;

FIG. 7 illustrates an example virtual environment representing a hotel room, according to an embodiment of the present invention;

FIG. 8 illustrates a hierarchy of sub-levels in an example virtual city, according to an embodiment of the present invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

In general, the present invention allows individuals, professionals, businesses, advertisers and other persons and organizations to perform integrated life activities in virtual cities hosted by a server accessible via the public Internet.

According to an embodiment of the present invention, an implementation of the invention includes a virtual cities server that is accessible via the public Internet via one or more domain names (e.g. www.eCity.com). In general, a virtual cities server hosts one or more virtual cities that allow users to interact virtually with regard to real life activities. The one or more virtual cities include one or more virtual environments, in which user interactions correspond to real life activities such as shopping, learning, and configuring a home appliance and may result in real life transactions and/or physical actions involving physical objects. The one or more virtual cities may also comprise a virtual world, in which users freely navigate from one virtual city to another virtual city.

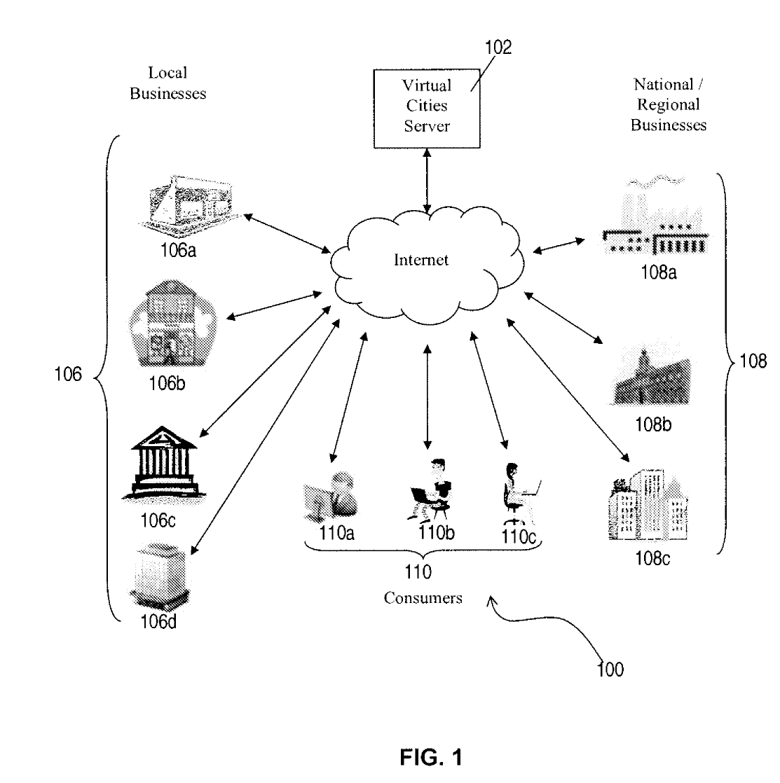

FIG. 1 illustrates exemplary system 100, which includes virtual cities server 102. As illustrated in FIG. 1, virtual cities server 102 may be accessed by local businesses 106 (e.g., 106a, 106b, 106c, and 106d), national/regional/international businesses 108 (e.g., 108a, 108b, and 108c), and consumers 110 (e.g., 110a, 110b, and 110c) via Internet 104. It should be apparent that there can be more than one virtual cities server, and that the Internet can include many different types of wired and wireless networks.

Virtual cities server 102 can be implemented by one or more servers such as those available from Sun, HP, BEA, etc. Virtual cities server 102 can further include associated software comprising, for example, operating system(s), web server(s), database server(s), and other server software. The virtual cities server 102 can maintain conventional user account information such as usernames, passwords, contact information, etc., either in databases or other locally or remotely accessible storages.

Users such as consumers 110 and businesses 106 and 108 can access the virtual cities server using any type of computing device a person can now or in the future use to access the Internet or other public network, and which can host at least Internet access hardware (not shown) and software such as a browser. In an example where users have a personal computer such as a Mac, PC, notebook or desktop computer, it typically includes an operating system such as Windows or Mac OS, a browser application such as Windows Explorer or Mozilla Firefox, and network access hardware such as a wired or wireless modem. Computing devices used by consumers and businesses further preferably include graphical displays (e.g. one or more LCD screens) and I/O devices (e.g. keyboard, mouse, keypad, scroll wheels, microphone, speakers, video or still camera, etc.) for providing a user interface within the operating system and communicating with users. Computing devices used by users are not limited to personal computers, but can include cellular phones, personal digital assistants (PDAs), game systems (e.g. Playstation, Wii, Xbox, etc.) or other devices, and those skilled in the art will understand how implementation details can be changed based on the particular type of host device.

Software or firmware may be located at each of the local businesses 106, national/regional/international businesses 108, and consumers 110, configured to work cooperatively with software or firmware operating on virtual cities server 102 for communicating with and obtaining content from virtual cities server 102. Content from virtual cities server 102 may be delivered as web pages, Flash media, HTML data, or other content that may be delivered via HTTP and other web delivery protocols.

Local businesses 106 can include stores, doctors, dentists, agencies, banks, professional services, car dealerships, movie theaters, etc. Local businesses 106 can also include non-commercial groups such as churches, government agencies, etc. Local businesses 106 can also include local branches of nationwide or regional businesses or organizations. National/regional/international businesses 108 can include manufacturers of consumer and industrial goods, financial organizations, governments, etc. It should also be apparent that the groups of local business, national/regional/international businesses, and consumers are not necessarily mutually exclusive. For example, a consumer can also have or be associated with a business. In addition, the groups of local business, national/regional/international businesses, and consumers also do not constitute an exhaustive list of the entities that may access virtual cities servers.

According to an embodiment of the invention, a virtual cities server hosts one or more virtual environments in which a user is able to interact with a virtual representation of a physical object, where the interaction can result in a transaction involving the physical object. The one or more virtual environmental are three-dimensional spaces, providing the user with a preferably, but not necessarily, three-dimensional virtual shopping experience.

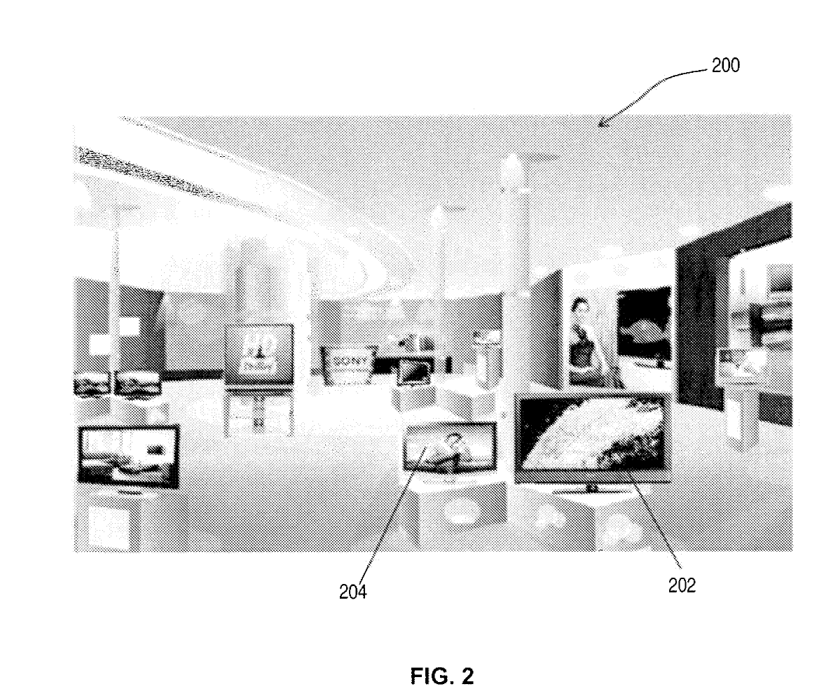

FIG. 2 illustrates an example virtual environment 200. Virtual environment 200 is a three-dimensional virtual space that is visually similar to an electronics store. Inside virtual environment 200, various television sets are visually depicted, or “displayed”. These television sets include television set 202 and television set 204. Both television set 202 and television set 204 are virtual representations, and may each represent a physical television set that is available for sale. Within virtual environment 200, a user may interact with any of the displayed television sets to gather more information. For example, the user may click on television set 202, and further information about television set 202 may be displayed in response to the click. The further information that may be displayed include, for example, different three-dimensional images of television set 202, demo videos showing the operation of television set 202, specifications of television set 202, etc.

After viewing and manipulating virtual representations of physical products, or virtual merchandise, the user may initiate and consummate a transaction involving the physical product associated with the virtual merchandise. For example, the user may decide to purchase the physical television set associated with television set 202. Within virtual environment 200 or another control or interface available to the user, the user may initiate and ultimately consummate a purchase transaction of the physical television set associated with television set 202. During the transaction, the user may specify a payment method (e.g., credit card number) and a physical delivery address. A vendor of the physical television set associated with television set 202 then receives the transaction details, including payment method and physical delivery address, and delivers the physical television set to the physical delivery address. In one approach, the transaction details may be automatically provided through information stored in the user's account on the virtual cities server.

A virtual environment may be operated by a vendor. For example, virtual environment 200 may be operated by a vendor who sells the physical television sets associated with the virtual television sets (e.g., television sets 202 and 204). The vendor may create and build the contents within virtual environment 200, including the layout, the virtual television sets, and the information associated with the virtual television sets. Content within a virtual environment can be made actionable, so that, for example, a user's click on a virtual television set may result in a demo video of the associated physical television set being played. In one approach, a vendor who wishes to operate a virtual environment pays a fee to gain access to the virtual environment. The fee may be structured as a sale or a lease of the virtual environment. The fee may also be structured as an ongoing fee that comprises a percentage of the sales in transactions conducted within the virtual environment. In another embodiment, a vendor may operate the virtual environment for free.

According to one embodiment, virtual environments within which a user is able to interact with a virtual representation of a physical object and conduct a transaction involving the physical object are part of one or more virtual cities hosted on the virtual cities servers. The virtual cities may, in turn, be part of a virtual world, where users can freely navigate within the virtual world, from virtual city to virtual city, and within the virtual cities. For example, a user may navigate to virtual city “New York”, navigate within virtual city “New York” to 45th Avenue, navigate within 45th Avenue to building 633, and then navigate within building 633 to an electronics store, where navigation to enter the electronics store results in virtual environment 200 being displayed.

In one approach, an user interacts with the virtual environments via an avatar. The avatar of a user may interact with virtual representations of physical merchandise, such as by “trying on” virtual clothing. In another approach, the user does not use an avatar, but interacts directly with the virtual environment via a mouse, another pointing device, or any other user-interface peripheral device.

In one approach, a virtual environment may be a street in a virtual city or any other public space in the virtual city, such as a park, and may comprise virtual representations such as virtual cars and virtual toys. Similar to the example virtual environment 200 in FIG. 2, a user may interact with virtual representations in non-store virtual environments to gather further information about the physical objects associated with the virtual representations and to conduct transactions involving the physical objects associated with the virtual representations. For example, a user may click on a virtual car parked on a virtual street to examine the corresponding physical car's specifications. If the user becomes interested in purchasing the corresponding physical car, the user can further conduct a purchase transaction similar to the transaction involving a television set described above. Vendors may similarly pay a fee to display virtual representations of physical merchandise in various non-store virtual environments in the virtual cities. In addition, virtual representations like virtual cars can be moving (e.g., virtual car traveling along virtual roadway) instead of static. As a result, a virtual city provides many opportunities for vendors to display virtual representations of physical merchandise and for users to browse and interact with the virtual merchandise to gather more information about the corresponding physical merchandise and ultimately purchase the physical merchandise.

According to further aspects of the invention, a visual search engine is provided to users within virtual cities. A user may enter a visual query into the visual search engine and in response receive a list of search results that are visual. For example, a user can click on an image of a chair, initiate a visual search based on the image of the chair (e.g., by dragging and dropping the image on a search control), and receive a list of search results of similar images (e.g., images of other chairs that are visually similar to the chair in the query image). The search result images may be virtual representations of physical chairs that are similar to the physical chair represented in the query image. Virtual representations may be graphics (e.g., a graphic of a physical chair) or photographs (e.g., a photograph of the physical chair). In this manner, the visual search engine provides an improved way of searching over conventional text-based search approaches, which is especially useful and powerful in searching for merchandise in a e-commerce context. It should be apparent that the visual search engine may also encompass text search capabilities, so that search results may contain textual as well as visual results and search queries may also be based on text search strings.

Additionally, a user may initiate a visual query by simply clicking, double-clicking, or mousing-over a virtual representation or a text in virtual cities. This feature eliminates the need for dragging and dropping to initiate queries. For example, a user can initiate a visual search based on a virtual representation of a chair by simply mousing over the chair and selecting a “search” option from a drop-down menu that appears when the chair is moused over. It should be apparent that other ways of query initiation through direct interaction with virtual representations (e.g., double-clicking on the virtual representation of the chair) are also possible in embodiments of the present invention.

In one aspect of the invention, the visual search engine can be employed in a context outside of virtual cities, such as conventional web pages. For example, a user may initiate a search on “red convertible” by clicking, on a web page, a text string “red convertible” or a picture of a red convertible. Search results may contain visual images, text, or a combination of both, substantially as described above. In this manner, the convenience of conventional web searches can be greatly enhanced through the elimination of query boxes and the ability to search based on visual images.

According to an embodiment of the invention, a virtual cities server hosts one or more virtual environments in which a user is able to interact with a virtual representation of a physical object, where the interaction can result in a physical action involving the physical object. The one or more virtual environmental are preferably, but not necessarily, three-dimensional spaces.

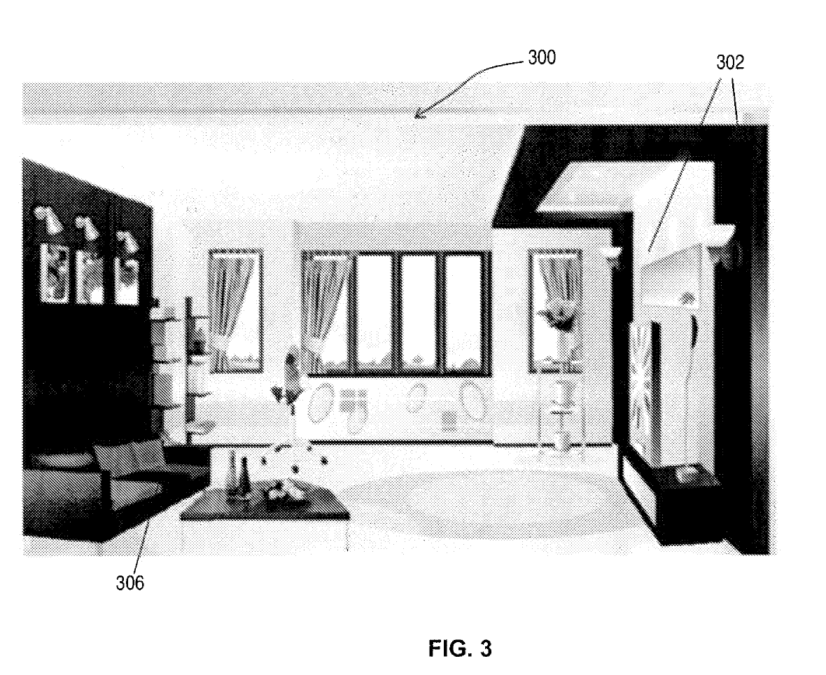

FIG. 3 illustrates an example virtual environment 300. Virtual environment 300 is a three-dimensional virtual space that is visually similar to a living room of a home. Inside virtual environment 300, various objects are visually depicted, such as lights 302, television 304, and sofa 306. Lights 302, television 304, and sofa 306 may each be a virtual representation of a physical object. For example, virtual environment 300 may have been set up by a user to depict her living room, and lights 302, television 304, and sofa 306 may represent corresponding lights, television, and sofa in the user's physical living room. In one example, lights 302 is set up such that a user may interact with lights 302 to control the corresponding lights 302. The user may click on lights 302 to bring up a control panel that allows the user to, for example, program the physical lights 302 to automatically turn on at 7:00 PM and turn off at 11:00 PM. In another example, a user interacts with the virtual representation of the alarm system in her house to turn the alarm system on and off. In yet another example, a user interacts with the virtual representation of an appliance in her house to control the appliance. Various known techniques can be used or adapted in accordance with the invention, such as web-enabled control of thermostats as employed in products from Proliphix, Inc. in Westford, Mass., and remote home monitoring and control techniques as employed in products available from Control4 in Salt Lake City, Utah.

According to one embodiment, virtual environments within which a user is able to interact with a virtual representation of a physical object and initiate a physical involving the physical object are part of one or more virtual cities hosted on the virtual cities servers. The virtual cities may, in turn, be part of a virtual world, where users can freely navigate within the virtual world, from virtual city to virtual city, and within the virtual cities. For example, a user may navigate to virtual city “New York”, navigate within virtual city “New York” to 45th Avenue, navigate within 45th Avenue to building 635, and then navigate within building 635 to apartment 12B, where navigation to enter apartment 12B results in virtual environment 300 being displayed.

In one approach, an user interacts with the virtual environments via an avatar. The avatar of a user may interact with virtual representations of physical object, such as by “sitting on” virtual sofa 306.

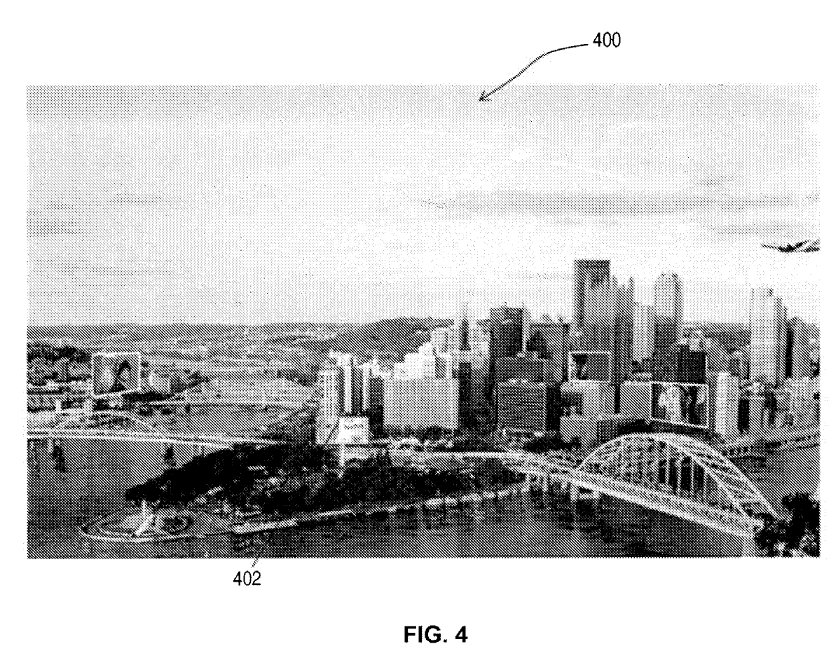

According to an embodiment of the invention, a virtual cities server hosts one or more virtual cities, which in turn include one or more virtual environments with which a user interacts, where the one or more virtual environmental are three-dimensional spaces. The one or more virtual cities correspond to one or more physical cities, and virtual environments in turn correspond to physical environments in physical cities. For example, the virtual cities server may host a virtual city “Pittsburgh” that corresponds to the physical city of Pittsburgh, Pa. FIG. 4 depicts an aerial view of virtual city “Pittsburgh” 400. Virtual city “Pittsburgh” may in turn include a virtual environment that corresponds to physical environments in Pittsburgh, Pa., For example, electronics store virtual environment 200 in FIG. 2 may correspond to a physical electronics store in Pittsburgh, Pa. and living room 300 in FIG. 3 may correspond to a physical living room in an apartment in Pittsburgh, Pa.

In one approach, the location of a virtual environment in a virtual city corresponds to the location of the corresponding physical environment in the corresponding physical city. For example, if the physical electronics store corresponding to the virtual electronics store 200 is located at 123 Second Avenue in Pittsburgh, Pa., then virtual electronics store 200 would also be located at 123 Second Avenue in virtual city “Pittsburgh”. In another approach, the virtual environment is depicted, within a virtual city, to be visually similar to the corresponding physical environment in the corresponding physical city. A virtual city may further include virtual environments that do not correspond to any physical environments. For example, virtual city “Pittsburgh” may include a virtual neighborhood “ABC” that has no corresponding physical neighborhood.

According to one aspect of the invention, users in virtual environments in a virtual city such as virtual city “Pittsburgh” 400 can interact with a virtual representation of a physical object to conduct a transaction involving the physical object, substantially as described in a previous section. According to another aspect of the invention, users in virtual environments in a virtual city such as virtual city “Pittsburgh” 400 can interact with a virtual representation of a physical object to initiate a physical action involving the physical object, substantially as described in a previous section. As described above, a virtual environment may be operated by a vendor, who may pay a fee in order to access the virtual environment. Also, a virtual environment may be operated by a user. For example, a user may modify the contents of a virtual house owned by the user. The user may also pay a fee in order to operate a virtual environment. Alternatively, operation of a virtual environment, such as a house, may be provided to the user for free.

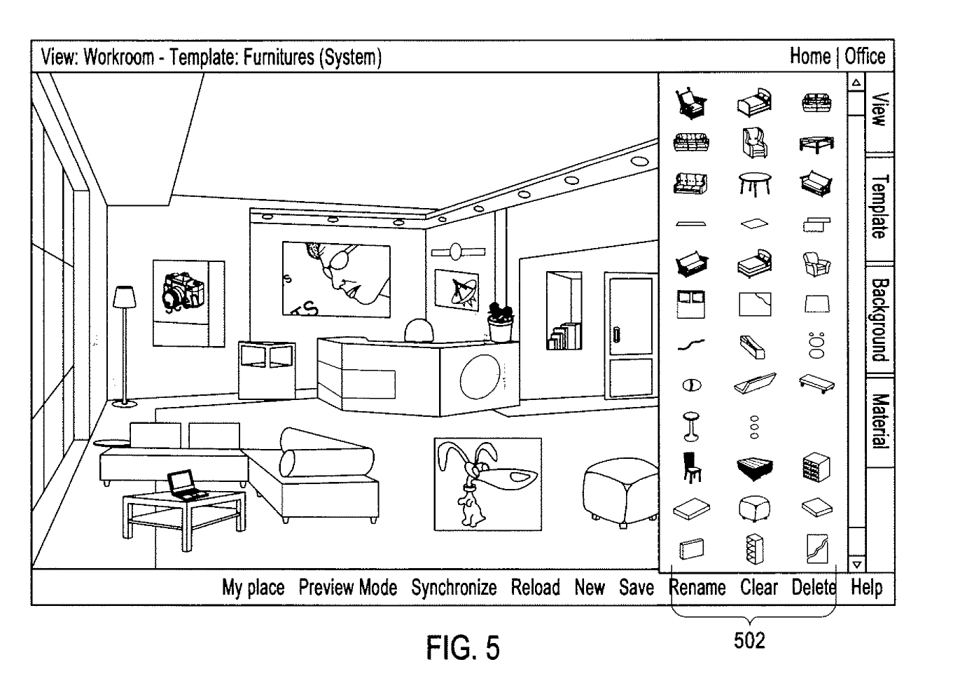

According to an aspect of the present invention, a user may build a virtual house and furnish the virtual house with virtual furniture. Living room 300 in FIG. 3 is an example of a virtual living room that contains virtual furniture (e.g., sofa 306). In decorating her virtual house, the user may select from a list of virtual furniture, such as virtual furniture list 502 in FIG. 5. Items in the virtual furniture list 502 may be virtual representations of physical furniture. Once placed in a virtual environment, a user may interact with a piece of virtual furniture to conduct a transaction that results in a purchase of a physical furniture corresponding to the virtual furniture, similar to the way a user interacts with television set 202 to purchase a corresponding physical television set. In this manner, a user may try out a variety of virtual furniture in her virtual house before selecting furniture pieces to purchase for her physical house. In a similar manner, a user may try out a variety of virtual goods that correspond to physical goods, where user interactions with the virtual goods result in providing the user with further information about the corresponding physical goods (e.g., whether a particular sofa would be visually appealing if put in the same room as a particular chair).

Vendors of physical goods may thereby “advertise” the physical goods through providing their virtual representations for use and manipulation by users. According to one embodiments, vendors are charged fees for providing virtual representations of physical goods to users, such as being listed on furniture list 502. In addition or in substitution, fees may be charged based on the purchase transactions of the physical goods through virtual environments.

According to another aspect of the present invention, the buildings in virtual cities include stores and shops that correspond to physical stores and shops in the corresponding physical cities. For example, the “Palo Alto, Calif.” virtual city can include virtual stores that correspond to stores actually located in Palo Alto, Calif., such as Fry's Electronics, Molly Stone's grocery store, Stanford University bookstore, the Apple store etc. The owner of a virtual store may be associated with the corresponding physical store. For example, Apple, which operates the physical Apple store in Palo Alto, Calif., may operate the corresponding virtual store in the “Palo Alto, Calif.” virtual city. In one approach, only owners who are associated with the corresponding physical store.

Users may browse, interact with, and purchase the physical products corresponding to the virtual products displayed in virtual stores that correspond to physical stores, substantially as described above with respect to FIG. 2. In one approach, a user utilizes a common shopping basket for various virtual stores located in the same virtual city. The user may “fill” the basket with merchandise from different stores and then purchase the merchandise in the basket through a single transaction. The purchases are then automatically sorted out, payments automatically reimbursed, and physical merchandise automatically ordered from the physical stores. Additionally, local delivery of the purchased merchandise may be coordinated.

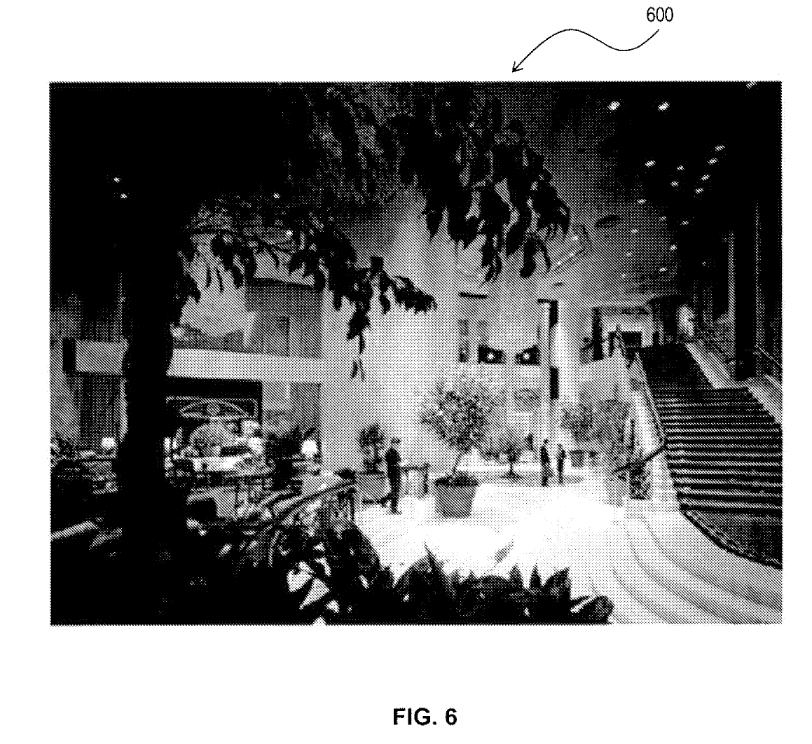

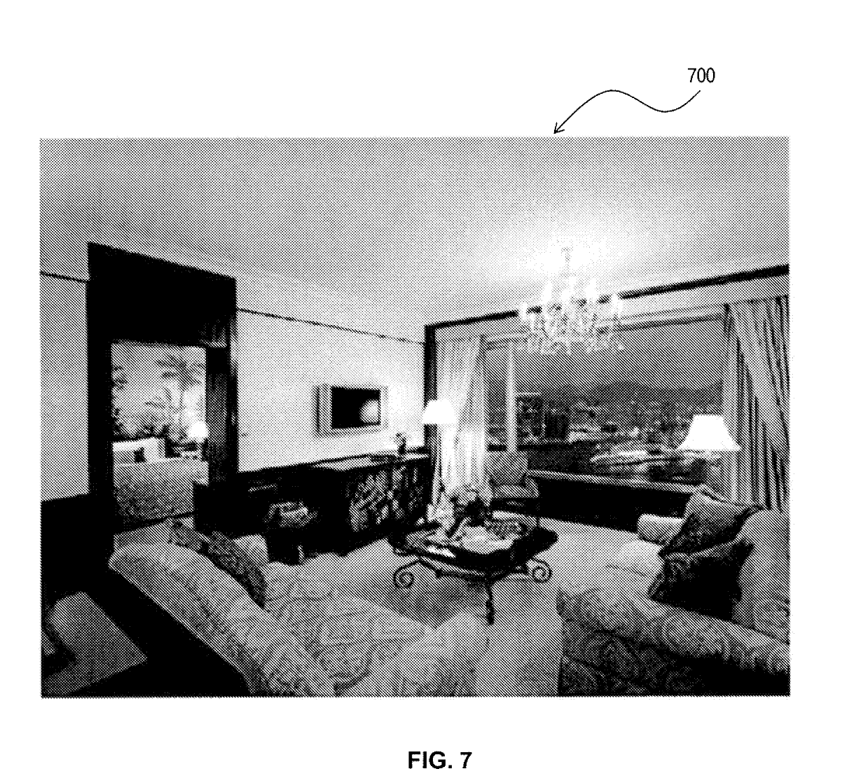

According to another aspect of the present invention, virtual shopping centers that correspond to physical shopping centers, such as the Stanford Shopping Center in Palo Alto, Calif., may be replicated in the corresponding virtual city. In addition, all types of businesses may operate virtual environments in a virtual city, including movie theaters, restaurants, and hotels. The specific interactions that a user conducts with a virtual environment may depend on the physical business corresponding to the virtual environment. For example, if the virtual environment represents a hotel, the user may browse the virtual hotel rooms within the virtual hotel and make reservations for the corresponding physical hotel rooms. FIG. 6 depicts a virtual lobby 600 of a virtual hotel. Through virtual lobby 600, a user may access virtual hotel room 700 of FIG. 7, and interact with virtual hotel room 700 by examining the amenities of virtual hotel room 700. If satisfied, the user can make a reservation of the physical hotel room corresponding to virtual hotel room 700 from within virtual hotel room 700 itself.

According to another aspect of the present invention, local landlords can build virtual replicas of offices, apartments, or other types of rental properties, enabling users who are potential tenants to participate in virtual tours or virtual open house of the available physical properties. In addition, potential tenants may also simulate the build-out of a physical space by configuring the corresponding virtual space.

According to another aspect of the present invention, vendors may purchase advertising in a virtual city through purchasing billboard space. Billboards, such as billboard 402 in FIG. 4, may display an advertisement whose content is actionable so that a user can view additional information when the billboard is acted upon (e.g., click or mouse-over). Content displayed in billboards may be still or moving images.

According to another aspect of the present invention, the virtual environments in virtual cities may correspond to businesses or organizations that provide services. For example, a virtual environment may correspond to a school, a church, a medical clinic, etc. User may, through interactions within a particular virtual environment, request and receive services through the particular virtual environment. For example, a user may enter a virtual classroom and attend a class, enter a virtual church and participate in a virtual religious service, or enter a virtual law firm and interact with a lawyer avatar to receive legal advice. Other services that can be provided in virtual environments include: wellness advice, religious advice, dating and relationship advice, horoscope advice, financial advice, and medical advice. Communication technologies such as instant messaging, group chat, video chat, VoIP calls, and other multimedia communications can be used to facilitate the request and delivery of such services.

According to another aspect of the invention, a virtual city may have several sub-levels, where each sub-level can represent one or more separate virtual divisions within which that users can navigate through, advertise in, and interact with other users and businesses. For example, a virtual city may have sub-levels corresponding to an entertainment district, an industrial district, and a commercial district. Users may further be provided with the ability to navigate from a sub-level of a particular virtual city to a corresponding sub-level of another virtual city.

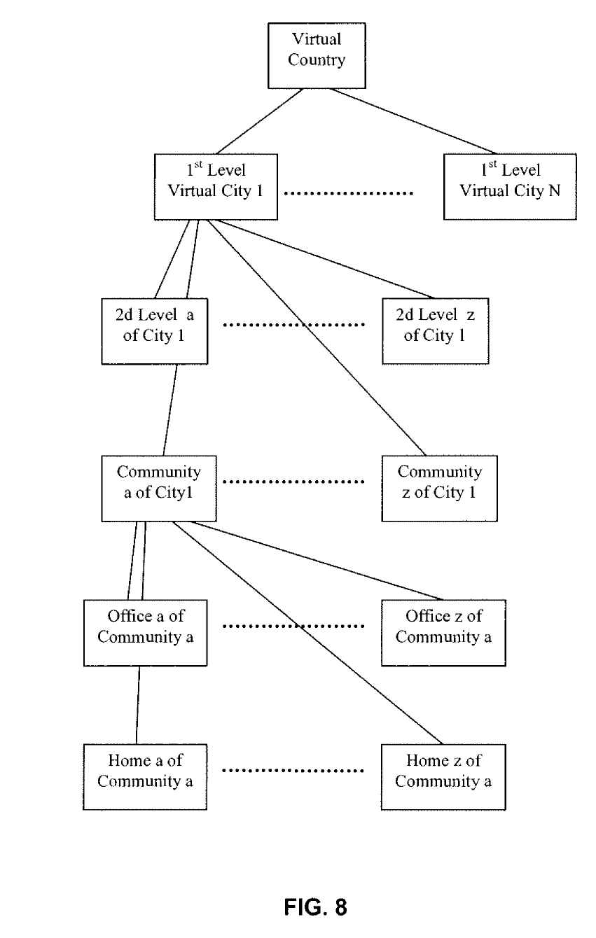

As shown in FIG. 8, virtual cities server can host one or more virtual cities 1 to N. These can be further included within one or more countries. For example, one virtual city can correspond to New York, within the United States. In the example of FIG. 8, each virtual city can have at least one sub-level, each of which may contain further sub-levels. As further shown in FIG. 8, each virtual city can further have one or more communities a to z. Communities can be associated with actual neighborhoods within the city, be completely virtual, or be a combination of both actual and virtual. Each community may further include offices and homes.

It should be noted that the levels illustrated in FIG. 8 are provided for illustration, and should not be considered limiting. Deep-level navigation not depicted in FIG. 8 is possible within virtual cities. For example, within buildings such as hotels, a user can navigate to a specific floor, to a specific hotel room on the specific floor, to a specific cabinet within the hotel room, etc. It should be apparent that virtual cities may be implemented with an unlimited number of sub-levels.

According to one aspect of the invention, the different sub-levels of a virtual city may correspond to different levels of suppliers in a supply chain that includes manufacturers, retailers, and intermediate suppliers, and management of a supply chain may be implemented through the virtual cities platform. For example, wholesalers can buy from factories, and retailers can shop from wholesalers or factories. Retails can further qualify with factories, thereby enabling “factory-direct” e-commerce. Transactions among the various levels of suppliers in a supply chain may be conducted in a visual manner, through user interactions with the virtual representations of the suppliers and the merchandise in virtual environments. For example, a factory may be represented by a virtual factory, within which users (e.g., wholesalers) can view the available goods and gather information about the available goods such as level of inventory and purchase price. In another example, when a consumer user purchases a good through a retailer virtual store (e.g., the television set purchase example based on FIG. 2), the retailer virtual store may be configured to automatically order the purchased physical television set from the virtual factory that represents the physical factory that manufactures the physical television set. Based on this example, it should be apparent that an entire supply chain may be managed within the virtual cities platform.

According to another aspect of the invention, users are provided with tools to access, from within the virtual world, a social networking website external to the virtual world. In one approach, an external website may be accessed by the user accessing a virtual environment operated by the external website. For example, a user may access the MySpace website through accessing a MySpace virtual building in the “Palo Alto, Calif.” virtual city. In another approach, a user may access the content of a social networking website in manner other than merely visiting the website. For example, a user may, through accessing the MySpace virtual building in the “Palo Alto, Calif.” virtual city, interact with MySpace members located in Palo Alto, Calif. In another approach, a virtual city may be accessed through an external website, such as MySpace.com. For example, the MySpace website may provide a user with an option to navigating to the MySpace virtual building in the “Palo Alto, Calif.” virtual city.

According to another aspect of the present invention, an application programming (API) that supports the building of content and applications in virtual cities is provided, thereby facilitating the efforts vendors and advertisers to build virtual representation in the virtual cities.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method comprising:
providing a virtual environment in which a user is able to interact with a virtual representation of a physical object, wherein:
the interaction between the user and the virtual representation of the physical object results in a transaction involving the physical object.

2. A method according to claim 1, wherein the virtual environment is a three-dimensional virtual space.

3. A method according to claim 1, wherein the virtual environment is part of a virtual world that comprises at least one virtual city.

4. A method according to claim 1, wherein the user interacts with the virtual representation of the physical object via an avatar.

5. A method according to claim 1, further comprising
providing a visual search engine to the user, the visual search engine capable of generating a list of search results in response to a query based on the virtual representation.

6. A method according to claim 1, further comprising:
providing a tool, to a vendor of another physical object, for adding a virtual representation of the other physical object to the virtual environment, the tool provided in response to a fee payment by the vendor.

7. A method according to claim 1 further comprising:
providing a tool, to a vendor of the physical object, for modifying the virtual representation of the physical object, the tool provided in response to a fee payment by the vendor.

8. A method comprising:
providing a virtual environment in which a user is able to interact with a virtual representation of a physical object, wherein:
the interaction between the user and the virtual representation of the physical object results in a physical action involving the physical object.

9. A method according to claim 8, wherein the virtual environment is a three-dimensional virtual space.

10. A method according to claim 8, wherein the virtual environment is part of a virtual world that comprises at least one virtual city.

11. A method according to claim 8, wherein the user interacts with the virtual representation of the physical object via an avatar.

12. A method according to claim 8, wherein:
the virtual environment is a virtual house that corresponds to a physical house;
the physical object is an alarm system of the physical house; and
the interaction between the user and the virtual representation of the alarm system results in a physical operation on the alarm system.

13. A method according to claim 8, wherein:
the virtual environment is a virtual house that corresponds to a physical house;
the physical object is an appliance of the physical house; and
the interaction between the user and the virtual representation of the appliance results in a physical operation on the appliance.

14. A method comprising:
providing a virtual world in which a user is able to interact with a virtual environment that corresponds to a physical environment, wherein:
the virtual world comprises a virtual city that corresponds to a physical city;
the virtual environment is located in the virtual city;
the location of the virtual environment in the virtual city corresponds to a geographic location of the corresponding physical environment in the corresponding physical city.

15. A method according to the claim 14, wherein the virtual environment is visually similar to the corresponding physical environment.

16. A method according to claim 14, further comprising:
providing a tool, to an owner of the virtual environment, for modifying the virtual environment.

17. A method according to claim 16, wherein ownership of the virtual environment is established in response to a fee payment.

18. A method according to claim 14, wherein the virtual environment is a virtual house that corresponds to a physical house.

19. A method according to claim 14, wherein the virtual environment is a virtual store that corresponds to a physical store.

20. A method according to claim 19, wherein the user is able to interact, within the virtual store, with a virtual representation of a physical product, the interaction between the user and the virtual representation of the physical product resulting in a transaction involving the physical product.

21. A method according to claim 16, wherein the virtual environment is a billboard that displays an advertisement.

22. A method according to claim 16, wherein the owner of the virtual environment is associated with the corresponding physical environment.

23. A method according to claim 16, wherein the user is able to receive services within the virtual environment.

24. A method according to claim 23, wherein the services include at least one of: education;
religious services; professional advice; and entertainment.

25. A method according to claim 14, wherein the user is able to interact, within the virtual environment, with a virtual representation of a physical object, the interaction between the user and the virtual representation of the physical object resulting in a physical action involving the physical object.

26. A method according to claim 14, wherein the virtual city comprises at least one sub-level, the at least one sub-level comprising at least one division.

27. A method according to claim 26, further comprising:
providing the user with a tool for navigating from a division of a sub-level of the virtual city to another division of another sub-level of another virtual city.

28. A method according to claim 14, further comprising:
providing a tool that allows the user to access, from within the virtual world, a social networking website external to the virtual world.

29. A method according to claim 14, further comprising:
providing an application programming interface (API) that supports the building of applications in the virtual world.
